(19) United States
(12) Patent Application Publication
(10) Pub. No.: US 2014/0304663 A1
(43) Pub. Date: Oct. 9, 2014

(54) Gesture Interface

(71) Applicant: Prashant Mishra, Redmond, WA (US)

(72) Inventor: Prashant Mishra, Redmond, WA (US)

(21) Appl. No.: 13/857,635

(22) Filed: Apr. 5, 2013

(51) Int. Cl. G06F 3/01

(52) U.S. Cl. CPC G06F 3/017
USPC 715/863

(57) ABSTRACT

The instant application discloses, among other things, techniques to allow simplified Gesture Interface, which may provide a consistent, easy-to-remember interface for performing various actions with a portable device, including, but not limited to, sharing files, data, and information, winking, waving, pointing, picking up, and dropping.

### FIELD

This disclosure relates to Gesture Interfaces.

### BACKGROUND

As mobile computers become more and more rampant, there is a higher demand for sharing of pictures, documents, videos, files, data and information in general among them.

These devices come from different manufacturers and have different operating systems, often making it difficult to know how to share files, data, and information and perform other actions.

### SUMMARY

The instant application discloses, among other things, techniques to allow simplified Gesture Interface, which may provide a consistent, easy-to-remember interface for performing various actions with a portable device, including, but not limited to, sharing files, transferring data and information, winking, waving, pointing, picking up, and dropping.

For example, a user may “throw” a smart phone—holding the phone while making a throwing action, which may cause the phone to send data to devices in the direction of the throw. “Throwing” a phone toward the sky may transfer data to the cloud.

A device being used to gesture may need a way to determine how it is being moved, and a form of wireless communication.

### BRIEF DESCRIPTION OF THE DRAWINGS

FIG. 1 is an example of a system on which Gesture Interface may be implemented according to one embodiment.

FIG. 2 shows a User 210 making a throwing gesture with User Device 110 in the direction of User Device 140.

FIG. 3 shows a User 210 making a waving gesture with User Device 110 in the direction of User Device 140.

FIG. 4 shows a User 210 making a winking gesture with User Device 110 in the direction of User Device 140.

FIG. 5 illustrates a component diagram of a computing device according to one embodiment.

### DETAILED DESCRIPTION

A more particular description of certain embodiments of Gesture Interface may be had by references to the embodiments shown in the drawings that form a part of this specification, in which like numerals represent like objects.

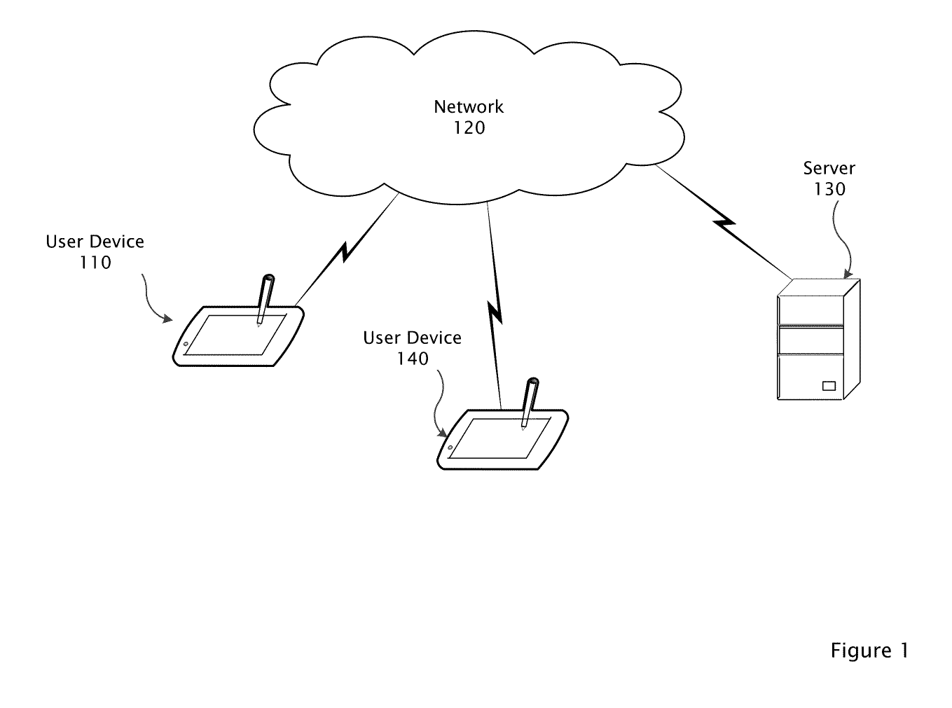

FIG. 1 is an example of a system on which Gesture Interface may be implemented. A user may use a Gesture Interface on User Device 110. If the user makes a throwing motion toward User Device 140, files, data or information may be sent to from User Device 110 to User Device 140. User Device 140 may, for example, be a portable device, a desktop computer, or any other type of device capable of storing files, data or information. If the user gestures throwing toward the sky, files, data, or information may be sent from User Device 110 to Server 130, which may, for example, be hosting a cloud-based file share.

Network 120 may include Wi-Fi, cellular data access methods, such as 3G or 4GLTE, the internet, local area networks, wide area networks, or any combination of these or other means of providing data transfer capabilities.

Server 130 may include one or more computers, and may serve a number of roles, including, but not limited to, storing content.

One skilled in the art will recognize that User Device 110, User Device 140, and Server 130 may be of different designs and capabilities.

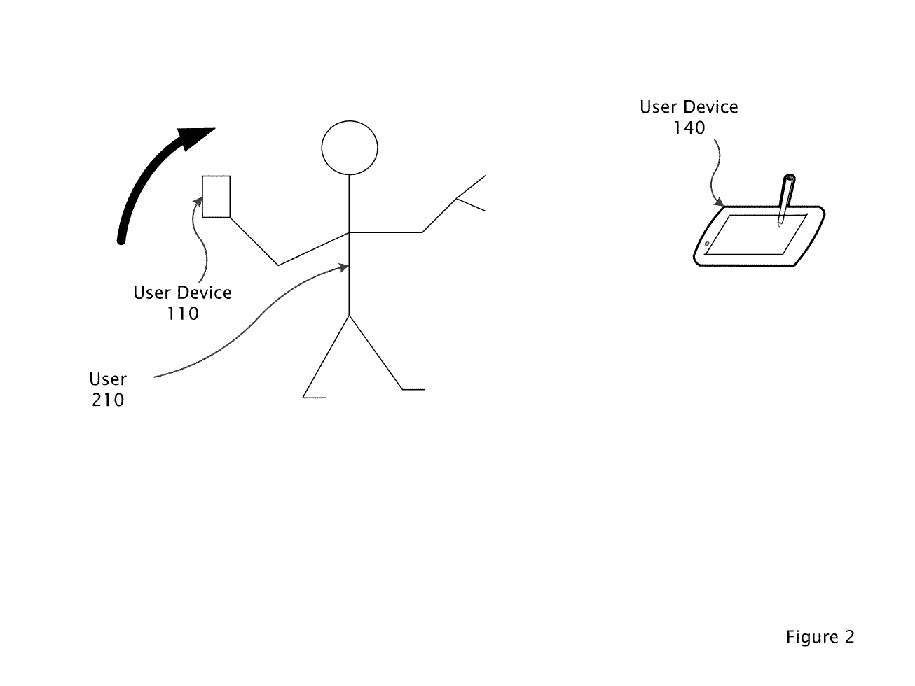

FIG. 2 shows a User 210 making a throwing gesture in the direction of User Device 140 with User Device 110. This movement could trigger an action, such as copying a file, data, or information, between the two devices. The action may be predetermined, and it may be configurable, so that different users may initiate different actions with the throwing gesture.

In one embodiment, User Device 110 may have one or more accelerometers, global positioning systems (GPS), or other way to determine its orientation and velocity to detect a gesture. User Device 110 may also know where User Device 140 is by communicating in real time, predetermining User Device 140's location, or polling after a gesture is made.

In another embodiment, there may be additional user devices in the general direction of User Device 140. A way of selecting which device or devices to interact with may be made available.

User 210 may also gesture throwing User Device 110 up, which may initiate and action to copy files, data, or information to a cloud location.

One skilled in the art will appreciate that many different actions may be initiated by a gesture, and that many different gestures may be used.

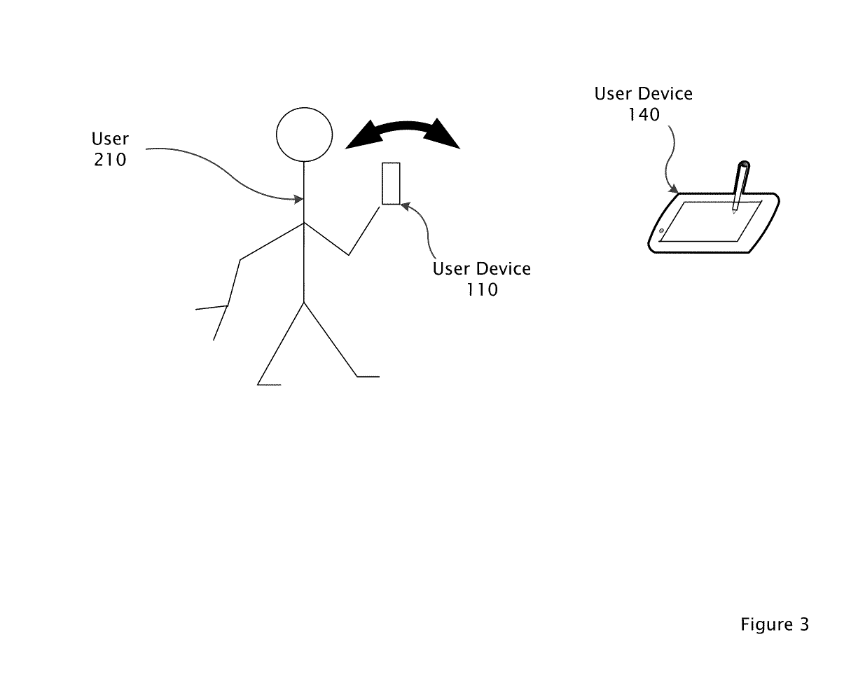

FIG. 3 shows a User 210 making a waving gesture with User Device 110 in the direction of User Device 140. Such a gesture may be used to initiate a “goodbye” action, for example ordering and sending a thank you gift.

There are many possible gestures which may be used; if a User Device has means to determine how it is moving, various gestures may be designed and implemented. A few examples may be:
a. Throwing
b. Catching
c. Dropping
d. Picking up
e. Pointing
f. Waving goodbye
g. Waving hello
h. Covering the screen
i. Winking

Various actions may be associated with gestures. A few examples may be:
a. A throw may be used for send file (copy), or move file. This may be used for one or more target devices. A throw may also be used to transfer data to a cloud. Overhand and underhand throwing gestures may be used to initiate different action.
b. A catch may be used to request data from another device.
c. Dropping may be used to transfer data to a device such as a home-based computer.
d. Picking up may be used to check in at an airport kiosk, or to obtain data from a home-based computer.
e. Pointing may signal a desire to link between two devices.
f. Waving goodbye may trigger the purchase of a thank you gift, or a sending of an email, text message, or photo to another device.
g. Pointing may be used to obtain additional information about a museum display, or may initiate a connection between two devices, or may send an introductory message to another device.
h. Covering the screen may shut the device off.
i. Winking, by turning the device from side to side quickly, may send a profile to one or more people, which may, for example, introduce the user to others at an event.

These examples of gestures and actions are not meant to be exhaustive or restrictive; one having skill in the art will recognize that many different gestures could be defined and many different actions could be assigned to any one or more of the gestures. In one embodiment, User 210 or a developer may design and implement custom gestures and actions. As another example, a disabled user may define a gesture requiring minimal movement to request help with something. As device location and movement detection capabilities improve over time, gestures may become more refined and subtle.

In another embodiment, the location of User Device 110 may be considered in determining which action to perform. For example, a dropping gesture may initiate a transfer of pictures to a home computer if the gesture is performed within a certain distance from home, but may transfer data to an office computer if it is performed in an office building.

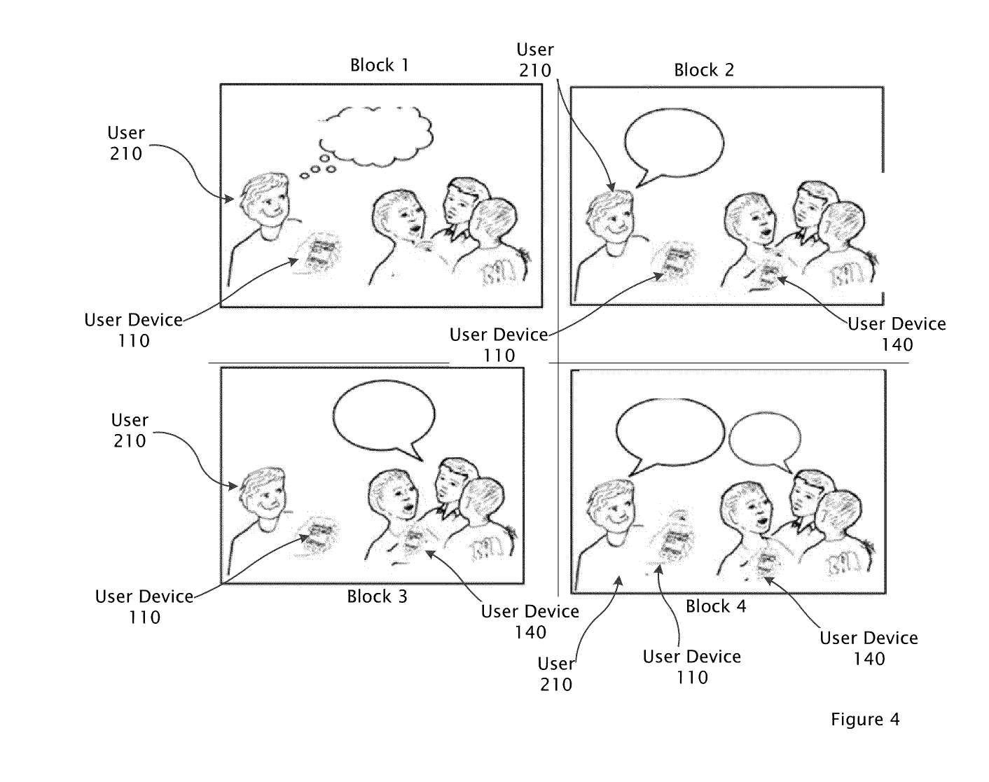

FIG. 4 shows a User 210 making a winking gesture with User Device 110 in the direction of User Device 140. In this example, in Block 1, User 210 may use a winking gesture to indicate he wishes to join a group at a bar. In Block 2, User 210 may share profile information with a member of the group, and, in Block 3, wait for an answer. In Block 4, User 210 may share why he wants to join the group, and a member of the group may respond with an answer.

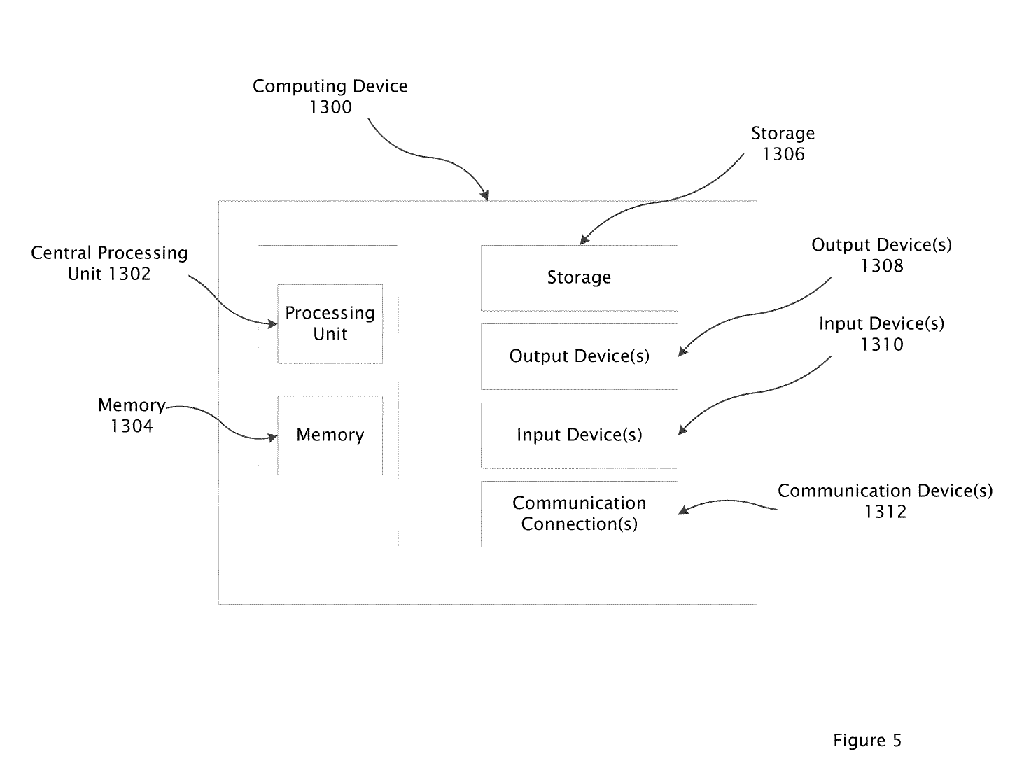

FIG. 5 illustrates a component diagram of a computing device according to one embodiment. The Computing Device (1300) can be utilized to implement one or more computing devices, computer processes, or software modules described herein, including, for example, but not limited to User Device 110, 610, or a Server 130. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, 610 or a Server 130. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1 310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
components operable by the processor, comprising:
a gesture detection component, configured to detect a movement of the system, determine a gesture corresponding to the detected movement;
an action determining component, configured to select an action to initiate in response to the determined gesture; and
an action initiation component, configured to initiate the selected action.

2. The system of claim 1, wherein the detection of a movement of the system is performed using an accelerometer.

3. The system of claim 1, wherein the detection of a movement of the system is performed using a global position device.

4. The system of claim 1, further comprising:
a location determining component, configured to determine a location of the system.

5. A method, comprising:
detecting a gesture by analyzing a movement of a device;
determining an action to perform based upon the detected gesture; and
performing the determined action.

6. The method of claim 5 wherein the device is a smart phone.

7. The method of claim 5 wherein the gesture is selecting from a group comprising: throwing, catching, dropping, picking up, pointing, waving goodbye, waving hello, covering the screen, and winking.

8. The method of claim 5, wherein the action is selected from a group comprising: send a file, move a file, transfer data to a cloud, request data from another device, transfer data to a device, check in at an airport kiosk, or to obtain data from a home-based computer, purchase a thank you gift, sending of an email, sending of a text message, sending of a photo, obtain additional information about a display, initiate a connection between two devices, send an introductory message to another device, and shut the device off.

9. A computer readable storage device containing instructions thereon which, when executed by a processor, perform a method comprising:
detecting a gesture by analyzing a movement of a device;
determining an action to perform based upon the detected gesture; and
performing the determined action.

10. The method of claim 9 wherein the device is a smart phone.

11. The method of claim 9 wherein the gesture is selecting from a group comprising: throwing, catching, dropping, picking up, pointing, waving goodbye, waving hello, covering the screen, and winking.

12. The method of claim 9, wherein the action is selected from a group comprising: send a file, move a file, transfer data to a cloud, request data from another device, transfer data to a device, check in at an airport kiosk, or to obtain data from a home-based computer, purchase a thank you gift, sending of an email, sending of a text message, sending of a photo, obtain additional information about a display, initiate a connection between two devices, send an introductory message to another device, and shut the device off.
